(19) United States
(12) Patent Application Publication
(10) Pub. No.: US 2010/0025410 A1
(43) Pub. Date: Feb. 4, 2010

(54) CONTAINER

(76) Inventor: CHIH HUNG CHIU, Jhongli City (TW)

Correspondence Address: HDLS Patent & Trademark Services, P.O. BOX 220746, CHANTILLY, VA, 20153-0746, US

(21) Appl. No.: 12/184,261

(22) Filed: Aug. 1, 2008

(51) Int. Cl. A47J 27/00; F24H 7/00

(52) U.S. Cl. 220/573.1; 126/400

(57) ABSTRACT

The present invention relates to an improved container, which is applicable to heating an object to be heated inside the container by radiation or conduction of thermal energy. The container has an outside surface on which at least one heat collector is provided and the heat collector is made of a material having excellent thermal conductivity, whereby the overall heat absorbing surface area of the heat absorbing section of the container is increased.

### BACKGROUND OF THE INVENTION

(a) Technical Field of the Invention

The present invention relates to a container, and in particular to an improved container that has an increased heat absorbing surface area to enhance the efficiency of the amount of heat transferred from a heating source such as a kitchen range to a container and to the object inside to be heated, which is conventionally very low.

(b) Description of the Prior Art

A conventional container usually has a smooth and flat bottom and surface area. To heat an object to be heated inside the container and to quickly increase the temperature thereof, a commonly adopted manner is to increase amount of heat output from the heating source, such as increasing the supply of gas or fuel to intensify the flame. However, since the efficiency of total amount of heat transferred from a heating source such as a kitchen range to a container and to the object to be heated inside is low, the above discussed method often causes a substantial waste of energy.

Thus, the present invention is aimed to overcome such a drawback by providing an improved container.

### SUMMARY OF THE INVENTION

The primary purpose of the present invention is to provide an improved container, which is applicable to heating an object to be heated inside the container by radiation or conduction of thermal energy, and is characterized in that the container has an outside surface on which at least one heat collector is provided, which is made of a material having excellent thermal conductivity and outwardly protruded from the surface of a heat absorbing section to thereby increase an overall heat absorbing surface area of the heat absorbing section of the container.

The heat collector can be of any stereoscopic configuration of any geometrical or irregular shape. The heat collector and the container can be of an integrally formed structure, or a jointing process can be employed to mount the heat collector to the outside surface of the container.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view illustrating heating of a conventional container;

FIG. 2 is a perspective view illustrating a container constructed in accordance with an embodiment of the present invention;

FIG. 3A is a cross-sectional view illustrating heating of the container of the present invention; and

FIG. 3B is a cross-sectional view of an enlarged view of a portion of the container of the present invention, illustrating the heating of the container.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

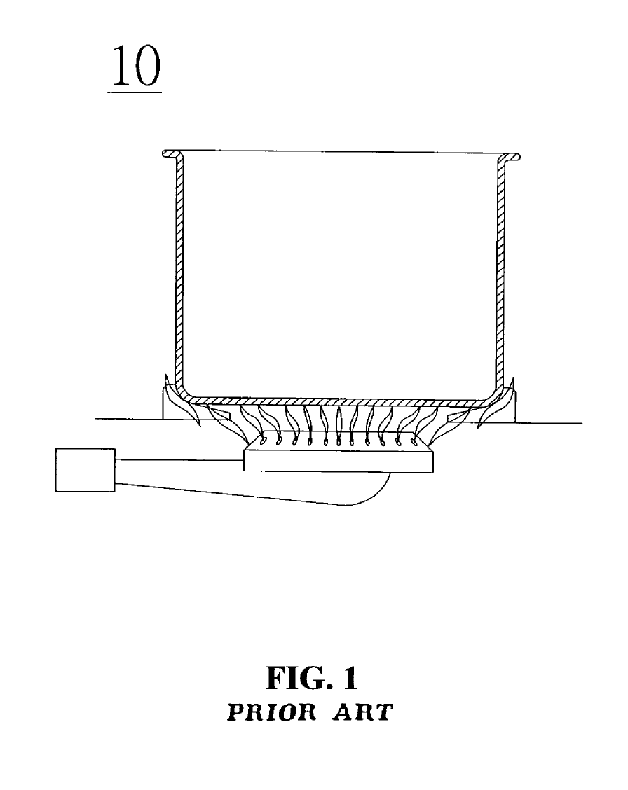

FIG. 1 illustrates a conventional container, such as conventional pot, positioned on a kitchen range for heating an object to be heated inside the container. Since a substantial portion of the thermal energy or heat generated from the flame of the range escapes into the atmosphere without being absorbed by the container, the heating efficiency of the conventional device is very poor.

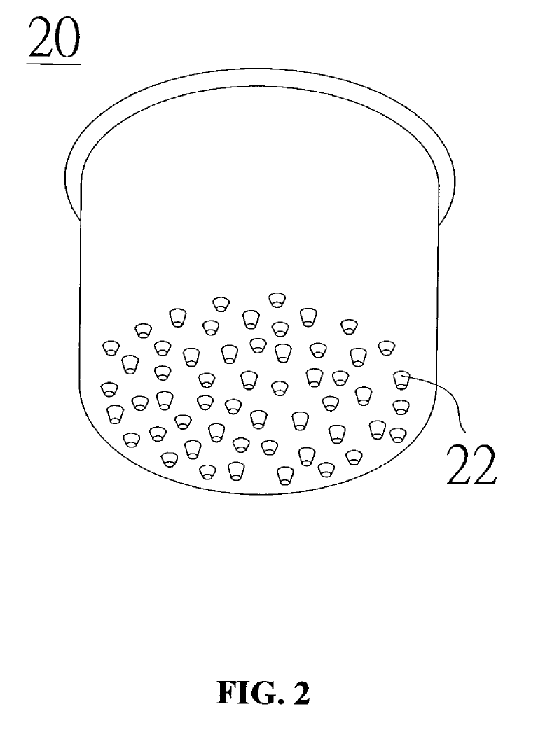

Reference is now made to FIG. 2, the present invention provides an improved container, which is generally designated at 20, and generally applicable to heating an object to be heated inside the container 20 through radiative and conductive of thermal energy (such as by means of open flame, hot steam, and electrical heating devices). The container 20 is characterized in that the container 20 has an outside surface on which at least one heat collector 22 is formed and distributed. The heat collector 22 is made of a material having excellent thermal conductivity, such as metal, to increase the heat absorbing surface area of a heat absorbing section of the container 20.

The heat collector 22 can be a group of multiple raised portions having a desired geometrical or irregular shape of a three-dimensional configuration, or a group of multiple heat conductive panels. The heat collector 22 and the container 20 can be made as an integrally formed structure or a jointing process is employed to mount the heat collector 22 to the outside surface of the container 20, or only the bottom of the container 20.

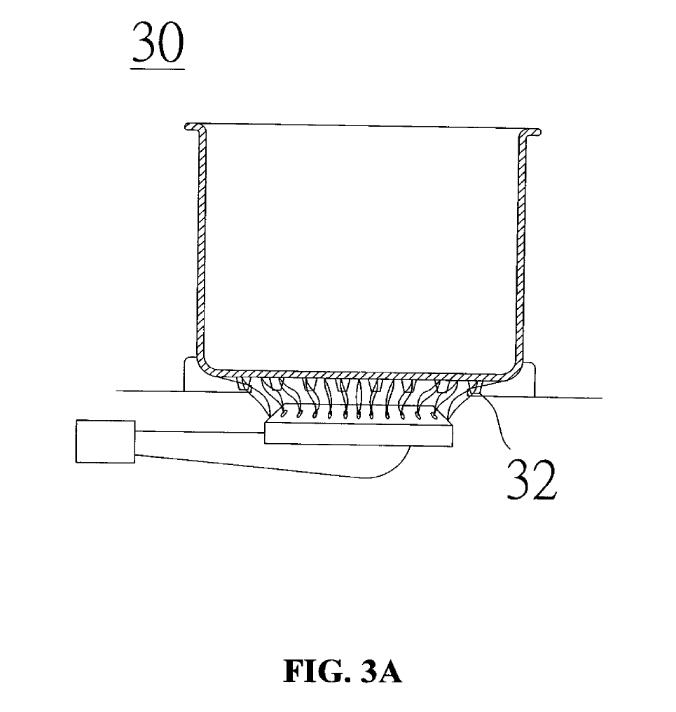

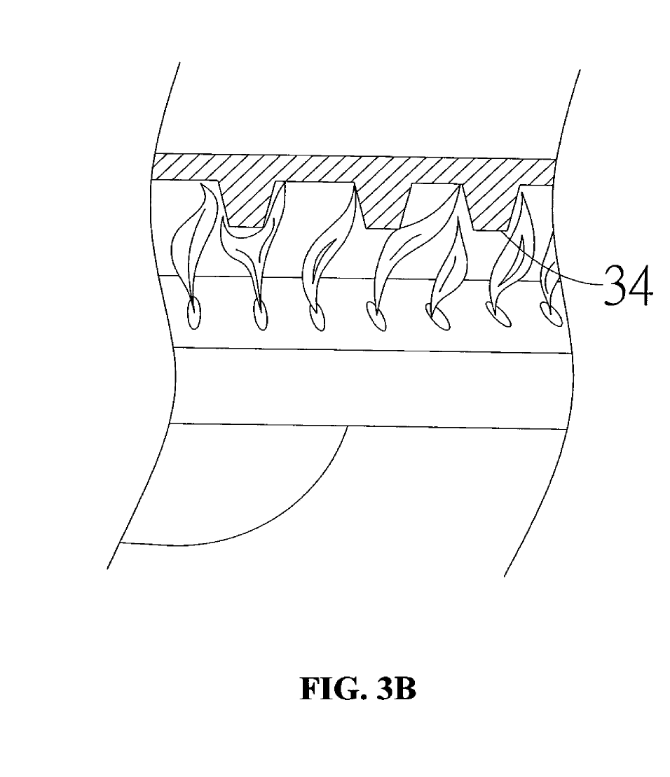

Also referring to FIGS. 2 and 3A, the container of the present invention provides an increased heat absorbing surface area thereby transfers more thermal energy to the object to be heated inside the container 20. Under the same condition of consuming equal amount of electricity or fuel, such as natural gas, PG or oil, the container of the present invention can heat the object to be heated to the desired temperature faster and thus effectively reduce the consumption of energy.

A further explanation will be made with reference to FIG. 3B. The heat collector 34 is made of a material that has excellent thermal conductivity and protruded from the surface of a heat absorbing section to increase the overall surface area of the heat absorbing section of a container which allows the flame to come in contact with the surface of the heat collector 34 for more efficient absorption of the thermal energy and the object inside the container can be heated faster and more efficiently. It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A container adapted to be used to receive an object to be heated and to heat the object through radiation or conduction of thermal energy, characterized in that the container has an outside surface on which at least one heat collector is formed and distributed, with the heat collector being made of a material having excellent thermal conductivity, to thereby increase a heating surface area of a heating section of the container.

2. The container as claimed in claim 1, wherein the heat collector has a structure comprised of a raised portion having a three-dimensional configuration of a predetermined geometrical or an irregular shape, or a heat conductive panel.

3. The container as claimed in claim 2, wherein the heat collector is integrally formed with the container.

4. The container as claimed in claim 2, wherein the heat collector is integrally formed with the container and is arranged on an outside bottom of the container.

5. The container as claimed in claim 2, wherein the heat collector is mounted to the outside surface of the container by a jointing process.

6. The container as claimed in claim 2, wherein the heat collector is mounted to an outside bottom of the container by a jointing process.

7. The container as claimed in claim 2, wherein the heat collector is made of metals.

8. The container as claimed in claim 2, wherein the heat collector functions to transfer thermal energy generated by flame, hot steam, or an electrical heater to the container.
